(19) United States
(12) Patent Application Publication
(10) Pub. No.: US 2020/0210121 A1
(43) Pub. Date: Jul. 2, 2020

(54) CELL LINE-BASED RASTER IMAGE DATA GENERATION

(71) Applicant: Hewlett-Packard Development Company, L.P., Spring, TX (US)

(72) Inventors: Bryan CRAMPTON, Corvallis, OR (US); Thomas J GILG, Corvallis, OR (US); Mahesh BALAKRISHNAN, Corvallis, OR (US); Balaram SAHU, Corvallis, OR (US); Prasanth GOPINATHAN, Corvallis, OR (US)

(73) Assignee: Hewlett-Packard Development Company, L.P., Spring, TX (US)

(21) Appl. No.: 16/615,737

(22) PCT Filed: Jun. 29, 2017
(86) PCT No.: PCT/US2017/039959

§ 371 Date: Nov. 21, 2019

(51) Int. Cl. G06F 3/12; G06K 15/02

(52) U.S. Cl. CPC G06F 3/1243; G06K 15/1836; G06F 3/1213; G06K 15/1848

(57) ABSTRACT

A technique includes processing first data representing a description of a page of a document that is associated with a plurality of cell lines and a plurality of objects to generate second data. The second data represents, for a given cell line of a plurality of cell lines, whether objects of the plurality of objects intersect in the given cell line. The technique includes generating raster image data for the given cell line for a printer based on the second data.

### BACKGROUND

For purposes of printing a document on a digital printing press, a document description file (a portable document file (PDF), for example) may be processed to generate raster image data for the press. The raster image data represents raster images for pages of the document. A raster image is a bit map, which defines a grid of pixels or pixel cells of a document page and defines colors or continuous tones for the pixels/pixel cells.

### BRIEF DESCRIPTION OF THE DRAWINGS

FIG. 1 is a schematic diagram of a system that includes a digital printing press according to an example implementation.

FIG. 2A is an illustration of a cell line table generated and used by a recomposition engine of the system of FIG. 1 according to an example implementation.

FIG. 2B depicts an example target cell line according to an example implementation.

FIGS. 3 and 6 are illustrations of source cell blending according to example implementations.

FIG. 4 is an illustration of an object intersection table generated and used by the recomposition engine of FIG. 1 according to an example implementation.

FIGS. 5, 7 and 8 are flow diagrams of techniques to generate raster image data according to example implementations.

FIG. 9 is a schematic diagram of an apparatus to generate raster image data according to an example implementation.

### DETAILED DESCRIPTION

Variable Data Printing (VDP) printing refers to a form of digital printing in which some variable objects, such as texts, graphics and images, may change from one printing of a document to the next; and other, reoccurring, or static, objects of the document do not change. As examples, VDP printing may be used for purposes of printing brochures, advertisements, announcements, and so forth, with information (mailing addresses, for example) that changes among the copies that are produced by the printing press. VDP may present challenges for print shops and their content creators due the changing content.

In general, to print a VDP document, a print server may analyze a document file that describes the VDP document, such as a portable document format (PDF) file to analyze the document file to identify the static and variable objects of the document. Once identified, the static objects may be processed to derive the corresponding raster image data, and the raster image data for the static objects may then be reused until no longer needed. Through the reuse of the raster image data for static image objects, computing intensive operations that may otherwise be used to produce raster images for the reoccurring static may be reduced.

The printer server may include a raster image processor that generates the raster image data for the pages of a document to be printed. One way for the raster image processor to generate the raster image data for a given document page is for the processor to allocate a region of memory for the entire page and use the memory region as a canvas. For this technique, for each object of the document page, the raster image data may write data to the region of memory to effectively form the object on the canvas and blend the object with any other objects that partially or wholly share the same space on the canvas.

Processing a given document page to generate raster data may, however, may be relatively inefficient, however, as such operations may consume a significant amount of memory and may be associated with relatively intensive computing operations. In accordance with example implementations that are described herein, a raster image processor, or recomposition engine, generates raster image data for a document page for one pixel cell row, or line, at a time; communicates the raster image data to a digital printing press; and then repeats the process until raster data for all of the pixel lines are communicated to the digital printing press. Generating raster image data in this manner reduces the load on memory and computing resources, as further described herein.

In the context of this application, a “pixel cell,” or “cell” is associated with an atomic spatial unit of an image, such as a raster image of a document page. For example, the raster image of the document page may be viewed as being formed from a rectangular grid of pixel cells. As an example, in accordance with some implementations, a “cell” may be associated with a single pixel may be associated with a particular color value. As another example, in accordance with some implementations, a “cell” may be a collection, or group, of spatially adjacent pixels, and the pixels of the cell may be associated with the same color. For example, the cell may be a block of 4×4 pixels that is associated with a particular color (i.e., the color is homogenous for the cell). In accordance with further example implementations, the pixel cell may be a block of pixels, which is associated with a continuous tone, such as, for example, an Indigo compressed format (ICF) continuous tone, or “contone.” In the following description, a pixel cell has an associated “value,” and the “value” may be a color, a contone, or another property for the pixel cell.

In accordance with example implementations that are described herein, the image of an object may be partitioned into pixel cells called “object source cells,” or “source cells.” The raster image of a document page may be partitioned into pixel cells called “target cells.” Moreover, a document page may be associated with “cell lines,” which may be viewed as the raster image of the document page being horizontally partitioned into rows. In accordance with example implementations, a cell line extends across the width of the raster image, and the cell line has a height of one cell. As such, in accordance with example implementations, the number of cell lines is equal to the height of the raster image in pixels divided by the pixel height of the pixel cell, and the number of cells per cell line is equal to the width of the raster image in pixels divided by the pixel width of the pixel cell.

In general, the objects (text or graphics, which are defined by a PDF file, for example) that are part of a given document page may be associated with different layers. The “layer” associated with an object refers to a plane in which the object lies and which is parallel to the document page. The layer number, or order, represents a depth dimension, or order, of the layer, and in accordance with example implementations, the layer number increases with distance from the plane in which the background of the document page lies.

Objects of a document page may partially or entirely intersect, or overlap; and whether or not object portions that are overlapped are visible in the raster image of the document page depends on the degrees of opaqueness of the overlapping pixel cells. For example, for a given document page, a pixel cell A of object A that is associated with layer number 3 may overlap a pixel cell B of object B that is associated with layer number 2. For this example, object B is located behind object A, and the pixel B may or may not be visible, depending on the degree of opaqueness of the pixel cell A. In this manner, in accordance with example implementations, a given pixel cell may be opaque, nearly opaque, nearly transparent or transparent. In accordance with example implementations, an opaque or nearly opaque pixel cell means that the cell blocks enough light to prevent the viewing of a pixel cell that is disposed at the same position and associated with a lower order layer. Moreover, in accordance with example implementations, a transparent pixel cell means that an underlying pixel cell is fully viewable; and a nearly transparent pixel cell means that values (contones or colors, depending on the particular implementation) for the cell and an underlying cell are combined, or blended. The process of determining a pixel cell value for overlapping, or intersecting, pixel cells is called “blending” herein.

In accordance with example implementations, the recomposition engine processes a document description file for purposes of generating a cell line table, which identifies, for each cell line associated with the document page, which objects are associated with the cell line. In other words, for each cell line, the cell line table identifies objects that are partially or fully contained in the cell line and the positions of the contained objects.

The recomposition engine, in accordance with example implementations, constructs an object intersection table from the cell line table for purposes of identifying intersections of objects (if any) for each cell line. Using the object intersection table, the recomposition engine may then process the cell lines (called “target cell lines” herein) one at a time and communicate raster image data to the digital printing press in corresponding units of data. In this manner, in accordance with example implementations, the recomposition engine may, for a given target cell line, determine whether objects overlap, or intersect, in the given target cell line, and based on a result of this determination, perform a blending of the intersecting source object cells (if any) for purposes of generating the raster image data for the target cell line. Moreover, as described herein, in accordance with example implementations, the recomposition engine may use the cell line intersection table to, for a given target cell line, optimize the generation of raster image data for the target cell line to accommodate the cases in which one or no objects are contained in the cell line or the case in which multiple objects exist for the cell line but do not intersect.

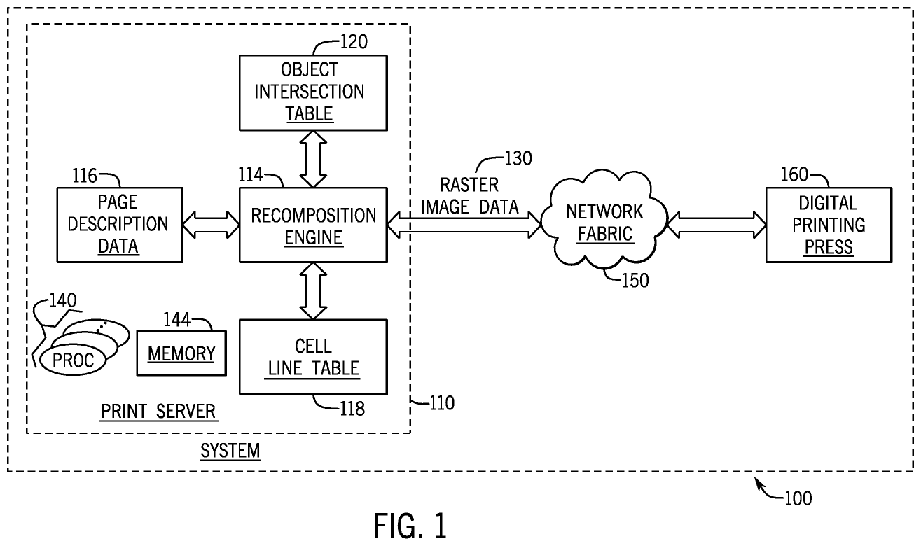

As a more specific example, FIG. 1 depicts a system 100 in accordance with some implementations. In general, the system 100 includes a recomposition engine 114 that receives page description data 116, which indicates, or represents, a description of one or multiple pages of a document to be printed. As an example, in accordance with some implementations, the page description data 116 may be data contained in a portable document file (PDF), which may describe one or multiple document pages to be printed. Moreover, in accordance with some implementations, the page description data 116 may describe static objects and variable objects associated with VDP. Regardless of its particular form, the page description data 116 describes a document page containing one or multiple objects, which the recomposition engine 114 processes to produce raster image data 130 for a digital printing press 160.

In accordance with example implementations, the raster image data 130 represents a single target cell line, of a document page. As described herein, the recomposition engine 114 constructs a cell line table 118 based on the page description data 116. The cell line table 118 identifies, per cell line, which object are objects are partially or entirely contained in the cell line. Based on the cell line table 118, the recomposition engine 114 generates an object intersection table 120, which, per cell line, identifies the positions of any object(s) contained in the cell line and whether objects overlap in the cell line. Based on the object intersection table 120, the recomposition engine 114 may then, generate the raster data 130 for each target cell line, as described herein.

Among the other features of the system 100, in accordance with some implementations, the print server 110 may include one or multiple processors 140 (one or multiple central processing units (CPUs), one or multiple processing cores, and so forth) and a memory 144. In general, the memory 144 is a non-transitory memory that may store data representing machine executable instructions (or software), which are executed by one or multiple processors 140 for purposes of performing techniques that are described herein. For example, in accordance with some implementations, the memory 144 may store machine executable instructions that when executed by the processor(s) 140 may cause the processor(s) 140 to perform functions of the recomposition engine 114 as described herein. The memory 144 may further store data representing initial, intermediate and final versions of the raster image data 130, as well as other data, in accordance with example implementations.

In accordance with some implementations, the memory 144 may be formed from semiconductor storage devices, memristors, phase change memory devices, non-volatile memory devices, volatile memory devices, a combination of one or more of the foregoing memory storage technologies and so forth.

In accordance with some implementations, the recomposition engine 114 may be partially or wholly based in software (i.e., formed by one or more of the processors 140, executing machine executable instructions). However, in accordance with further example implementations, the recomposition engine 114 may be formed partially or in whole from one or multiple hardware circuits such as one or multiple field programmable gate arrays (FPGAs) or application specific integrated circuits (ASICs).

As depicted in FIG. 1, in accordance with some implementations, the raster image data 130 may be communicated to the digital printing press 160 over network fabric 150. In accordance with example implementations, the network fabric 150 may be formed from components and use protocols that are associated with any type of communication network such as (as examples) Fiber Channel Networks, iSCSI networks, ATA over Ethernet (AoE) networks, HyperSCSI networks, local area networks (LANs), wide area networks (WANs), global networks (the Internet, for example), or any combination thereof.

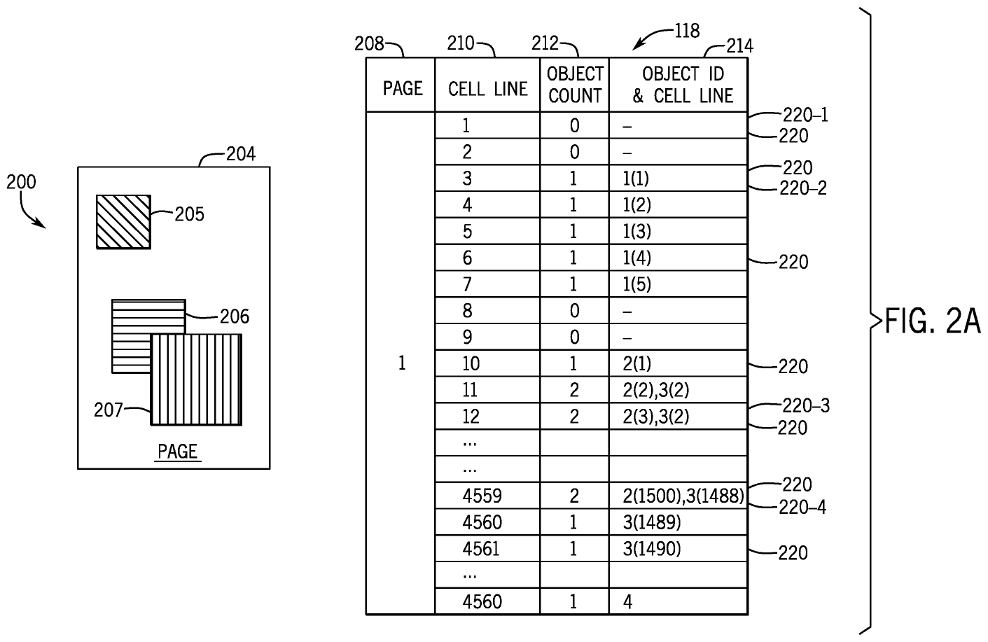

FIG. 2A is an illustration 200 depicting an example cell line table 118 that is generated by the recomposition engine 114 (FIG. 1) from an example page 204 of a document to be printed. The document page 204 contains, for this example, three objects 205, 206 and 207. Moreover, the object 206 is associated with a lower layer than the object 207, and the object 207, where the objects 206 and 207 overlap, is opaque or partially opaque (i.e., the portion of the object 206 where the objects 206 and 207 overlap cannot be seen).

The corresponding cell line table 118 may contain rows 220, where each row 220 describes the object or objects that may be contained in a cell line that is associated with the row 220. In this manner, in accordance with example implementations, the cell line table 118 includes a column 208, which identifies the particular target page 204. The cell line table 118 includes a column 210 identifying the cell lines associated with the target page 204. The number of cell lines may be equal or less than the number of vertical pixels on the page, depending on the cell size. For example, if the page 204 contains 8000 pixels in height and the compression ratio is 4:1 (i.e., 4 associated pixels per cell), then there are 2000 cell lines and 2000 corresponding rows 220 of the table 118. Each cell line, in turn, may contain, or hold, zero, one or more objects. For example, the row 220-1 corresponds to example cell line number one, and example cell line 220-4 contains information for cell line number 4559.

In accordance with example implementations, the table 118 further includes a column 212 identifying an object count for the number of implicated objects in the target cell line. For the example page 204, the object 205 does not coincide with any other object. Therefore, for the example cell line table 118, the object 205 is represented in the table 118 (as Object ID=1) with corresponding rows 220 having an object count of “1.” To the contrary, the objects 206 and 207 (represented by Object ID=2 and Object ID=3, respectively overlap, and correspondingly, rows 220 of the cell line table 118 have an object count of “2” where the objects 206 and 206 overlap. As more specific examples, row 220-1 of the cell line table 118 contains an object count of “0” representing that no objects are contained in the first cell line of the page 204. As another example, row 220-3 of the table 118, is associated with cell line number 12, contains the objects 206 and 207, and has an object count of “2.”

In accordance with example implementations, the cell line table 118 includes an object identification and cell line column 214, which contains an identifier for each object that is associated with the cell line and the particular cell line number of the object. For example, row 220-3 of the cell line table 118, which corresponds to cell line number 12, has the following entries: “2(3),” which identifies object number “2” (the object 206), and the “(3)” represents that the cell line number 12 contains row number three of the object 206; and the column 214 entry for the row 220-3 further represents that cell line number 12 contains object number 3 (i.e., the object 210) and contains cell line number two for the object.

FIG. 2B depicts an example target cell line 250 in its final state, accordance with example implementations. In particular, the target cell line 250 corresponds to row line 220-4 of the cell line table 118 and thus, corresponds to the intersection of objects 206 and 207 in cell line number 4559. The target cell line 250 contains a group 254 of cells in cell positions numbers 1 to 9, which contain background fill color as there are no objects for these cells. Due to the grouping of contiguous cells that have the same cell value, in accordance with example implementations, the group of cells 254 may be represented in the raster data 130 (FIG. 1) by compressed data, such as, for example, data that represents run length encoding or Indigo compression format (ICF) encoding, as examples. The target cell line 250 for the example of FIG. 2B also contains cells 258 in cell positions 10 to 19, which correspond to the intersection of the objects 206 and 207 in cell line number 4559. The cells 258, which have the same associated values, may also be encoded, or compressed. The target cell line 250 further includes a group of cells 262 in cell positions 20 to 28, which corresponds to the object 207, where the objects 206 and 207 do not overlap. In a similar manner, due to the cells 262 corresponding to the same value, the cells 262 may be compressed, or encoded. Finally, for example target cell line 250, the cell line 250 contains another group 266 of cells in positions 29 and 30, which are associated with the background color, or no fill.

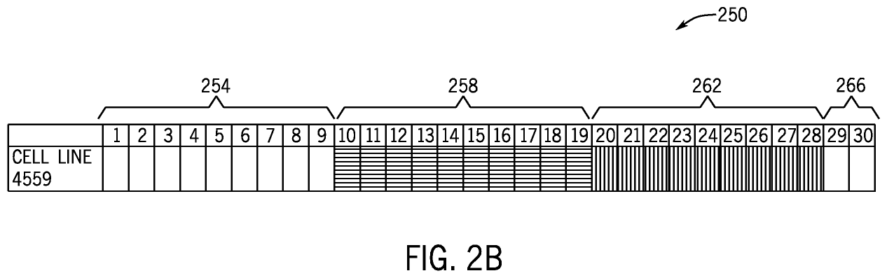

In accordance with example implementations, the recomposition engine 114 (FIG. 1) combines, or blends, overlapping object source cells using reverse z-order blending, where “z” represents the page depth dimension. In particular, FIG. 3 is an illustration 300 of z-order blending for three target cells 310, 314, 318 and 320, in accordance with example implementations. Moreover, FIG. 3 depicts source cells associated with four non-background layers 302, 303, 304 and 305. In particular, for this example, the layer 305 is the lowermost layer (i.e., layer number 1), the layer 304 is the next highest layer (i.e., layer number 2), the layer 303 is the third highest layer (i.e., layer number 3), and the layer 302 is the uppermost layer (i.e., layer number 4). The reverse z-order blending, as its name implies, proceeds in a direction opposite to the z axis (i.e., proceeds in a direction into the page).

The recomposition engine 114 performs the reverse z-order blending by beginning with the uppermost layer 302 and stopping when an opaque or nearly opaque source cell is encountered. For example, for the target cell 310, the reverse z-order blending views the cells along a reverse z direction 330. In this direction, the blending first encounters a nearly transparent source cell 332 that is associated with the uppermost layer 302. Because the source cell 332 is neither nearly opaque nor opaque, the processing continues along the direction 330, and as shown, source cells 334 and 336, which are associated with the next two layers 303 and 304 are transparent. Therefore, processing along the direction 330 continues to the lowest layer source cell 338, which, for this example, is opaque or nearly opaque. Accordingly, the recomposition engine 114 assigns the value of the source cell 338 to the target cell 310.

The value for the target cell 318 is derived by processing in a reverse z-order direction, as indicated at reference numeral 350. As shown, source cells 352 and 354, which are associated with the uppermost 302 and next uppermost 303 layers, are transparent. However, a source cell 356 of the next layer 304 is opaque or nearly opaque. Therefore, the reverse z-order processing stops at the second layer 304, as the value of the source cell 356 sets the value for the target cell 318. It is noted that the reverse z-order processing ends at the layer 304, as due to the opacity of the source cell 356, the values of any source cells below the cell 356 do not contribute to or affect the value of the target cell 318. In a similar manner, for purposes of determining the color value for the target cell 320, the recomposition engine 114 proceeds in a reverse z-order direction, as indicated by reference numeral 370. The processing ends at the layer 303, as the corresponding source cell 374 is opaque or nearly opaque, thereby providing the value for the target cell 320.

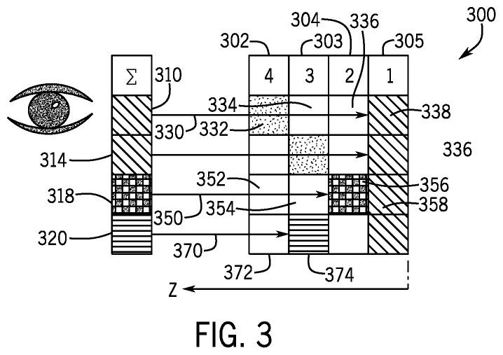

FIG. 4 depicts an illustration 400 of an example object intersection table 120 for an example page 410. For the page 410, a cell is formed by a block of pixels, and the cells that correspond to the page 410 are represented by a grid. The page 410 contains a source object 420, which is overlapped by another object 422. Moreover, page 410 contains a third object 424, which does not overlap either object 420 or 422. In the corresponding object intersection table 120 that is depicted in FIG. 4, rows 460 of the table 120 correspond to the pixel cell lines associated with the page 410.

In accordance with example implementations, each row 460 of the object intersection table 120 identifies the object intersection(s), if any, for an associated cell line. In accordance with example implementations, the object intersection table 120 includes a column 450 that contains a cell line identifier (1, 2, 3, and so forth) identifying the cell line for the associated row 460. Moreover, the object intersection table 120 includes a column 452 that identifies information pertaining to the objects that are contained in the associated cell line.

For example, row 460-2 contains information pertaining to cell line number “15,” which is highlighted and assigned reference numeral 430 on the page 410. For the row 460-2, the column 452 contains three entries: an entry for each object of the cell line. Each entry, in turn, describes an identifier for the object, the cell line on which the object begins, the horizontal cell offset for the object, and the horizontal length of the object. For example, for the first entry in column 452 for the row 460-2, the entry is “1:11:5:12,” which means object number 1 (i.e., object 420) begins on cell line number “11,” begins on cell “5” of the cell line, and has a length of “12” contiguous cells.

As also depicted in FIG. 4, in accordance with some implementations, the object intersection table 120 contains a column 454, which indicates whether the objects of the associated cell line intersect, or overlap. In this manner, in accordance with some implementations, the column 454 contains a Boolean value that is “True” to indicate object overlap and is “False” to indicate that no objects overlap in the associated cell line. For example, for example row 460-1, the object 420 (i.e., object “1”) appears in the associated cell line and no other objects appear in the cell line; and as such, the corresponding Boolean value in column 454 is “False.” However, for example row 460-2, three objects overlap, thereby corresponding to a Boolean value of “True” in the column 454.

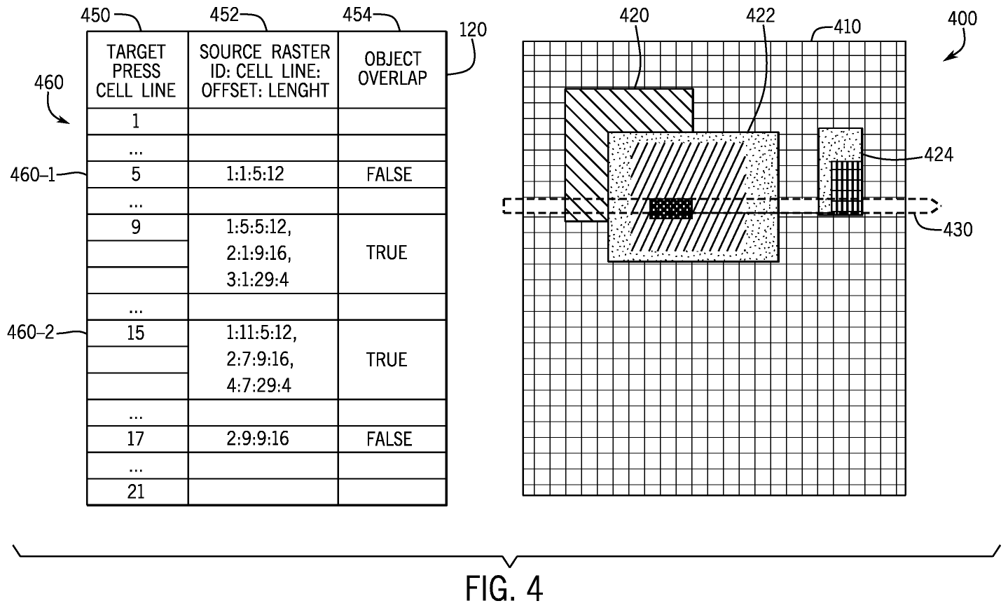

Referring to FIG. 5, in accordance with example implementations, the recomposition engine 114 uses the object intersection table 120 pursuant to a technique 500 for purposes of generating raster image data for a document page. In particular, pursuant to the technique 500, the recomposition engine 114 first generates (block 504) an object intersection table for the page and then reads (block 508) source cell data for the next target cell line to be processed. From this data, the recomposition engine 114 determines (decision block 512) whether any source object is implicated for the target cell line. If so, then, in accordance with example implementations, the recomposition engine 114 sets the raster image data equal to the encoded background data and communicates (block 520) the raster image data for the target cell line to the printing press 160 (FIG. 1). Moreover, if a determination is made (decision block 524) that another target cell line is to be processed, control returns to block 508.

If one or more source objects are implicated for the target cell line (per decision block 512), the recomposition engine 114 determines (decision block 530) whether a single source object is implicated for the target cell line; and if so, the recomposition engine 114 sets the raster image data equal to the encoded source cell data, pursuant to block 534 and communicates the raster image data to the printing press pursuant, to block 520.

In accordance with example implementations, if two or more source objects are implicated for the target cell line, then, pursuant to block 538, the recomposition engine 114 initializes a transparent target cell line, pursuant to block 538. If the recomposition engine 114 then determines (decision block 542) that an intersection or overlap between source objects occur for the cell line, the recomposition engine 114 decodes (block 546) the source cell line data and blends (block 550) the sources of line data using the target cell line. The recomposition engine 114 then sets the raster image data equal to the encoded blended source cell data, pursuant to block 544 to form the raster image data that is communicated to the digital printing press 160. Otherwise, if the multiple objects do not overlap for the target cell line (as determined in decision block 542), the recomposition engine 114 combines (block 558) the source cell lines without decoding to form the raster image data.

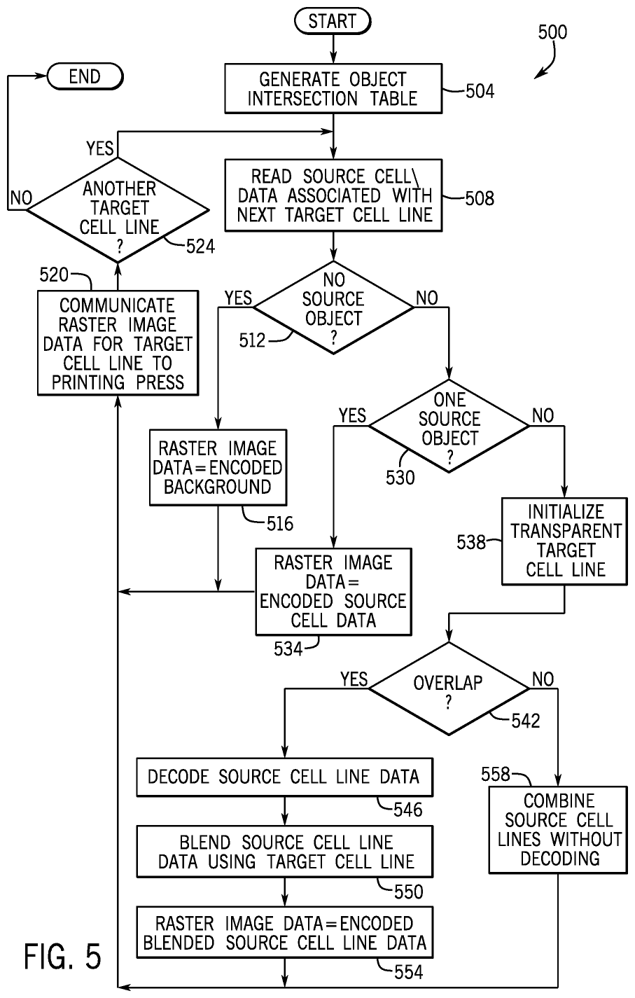

FIG. 6 depicts an illustration 600 of blending of object source cells to create a target cell line in accordance with example implementations. In this manner, for the blending, the recomposition engine 114 first initializes a transparent target cell line (i.e., the target cell line in its initial state) and then begins with source cell(s) from the uppermost layer 610 (i.e., layer number 4 for this example), which for this example, contains an object source cell 614. The recomposition engine 114 then modifies the transparent target cell line to create an intermediate state target cell line 618 that incorporates the object source cell 614. For this example, no objects exist in the next lower layer (here, layer number 3). However, the next lower layer (here, layer number 2) contains object source cells 620, 624 and 626, which are opaque or nearly opaque. The recomposition engine 114 accordingly combines the object source cells 620, 624 and 626 with the target cell line 618 to produce another intermediate state target cell line 630.

The lowest layer for the sources (layer number 1 for this example) contains three object source cells 640, 644 and 648, which are nearly transparent. The recomposition engine 114 correspondingly produces another intermediate target cell line 660, and for the transparent cell line 660, the source cell 640 modifies the previous target cell line 630. Due to the near transparency of the source cells 644 and 648, these cells do not modify the cell line 630. Lastly, in accordance with example implementations, the recomposition engine 114 may create the target cell line in its final state by blending a background color with the cells of the target cell line 660. In this blending of the background color, the transparent cells are filled with the background color, and the cell 640, being nearly transparent, is blended with the background color. The remaining cells are not blended with the background color, as these cells are opaque or nearly opaque. The recomposition engine 114 may then communicate raster image data representing the target cell line, in its final state, to the digital printing press 160.

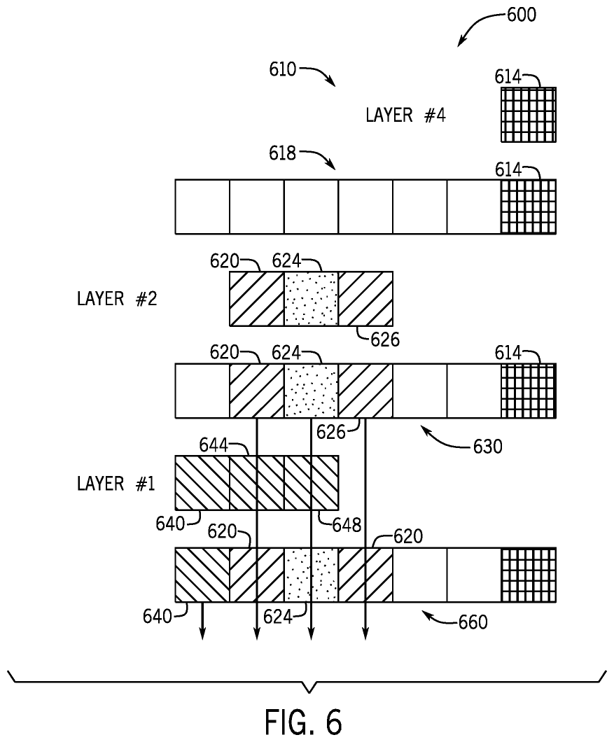

Referring to FIG. 7, thus, in accordance with example implementations, a technique 700 may be used to generate raster image data for a document page. In particular, the technique 700 includes processing (block 704) first data representing a description of a page of a document associated with a plurality of cell lines and a plurality of objects to generate second data representing, for a given cell line, whether objects intersect in the given cell line. The technique 700 includes generating raster image data for a given cell line for a printer based on the second data, pursuant to block 708.

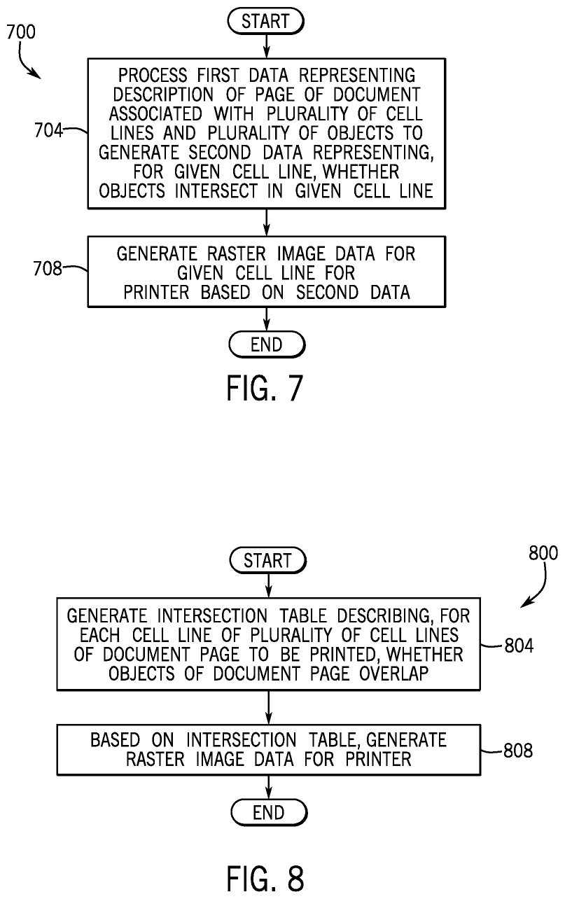

More specifically, in accordance with example implementations, a technique 800 that is depicted in FIG. 8 includes generating (block 804) in an intersection table describing, for each cell line of a plurality of cell lines of a document page to be printed, whether objects of the document page overlap. Pursuant to block 808, raster image data for the printer is generated based on the intersection table.

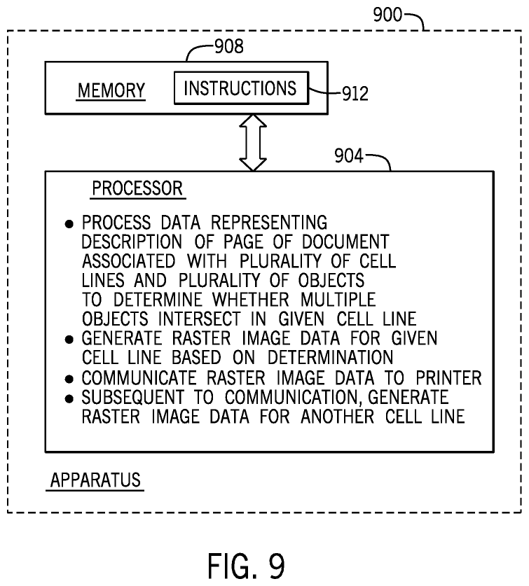

Referring to FIG. 9, in accordance with some implementations, an apparatus 900 includes a memory 908 and a processor 904. The memory 908 stores instructions 912 that, when executed by the processor 904, cause the processor 904 to process data representing a description of a page of a document associated with a plurality of cell lines and a plurality of objects to determine whether multiple objects intersect in a given cell line. The instructions 912, when executed by the processor 904, cause the processor to generate raster image data for a given cell line based on the determination, communicate the raster image data to a printer, and subsequent to the communication, generate raster image data for another cell line.

While the disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
processing first data representing a description of a page of a document associated with a plurality of cell lines and a plurality of objects to generate second data representing, for a given cell line of the plurality of cell lines, whether objects of the plurality of objects intersect in the given cell line; and
generating raster image data for the given cell line for a printer based on the second data.

2. The method of claim 1, wherein:
the second data represents an intersection table storing, for each cell line of the plurality of cell lines, an indicator associated with said each cell line representing whether objects of the plurality of objects intersect in said each cell line; and
generating the raster image data comprises referencing the intersection table based on an identifier associated with the given cell line to retrieve an indicator representing whether objects of the plurality of objects intersect in the given cell line and processing the first data based on the indicator.

3. The method of claim 2, wherein generating the raster image data comprises:
in response to the indicator representing that objects of the plurality of objects intersect in the given cell line, blending objects that intersect in the given cell line.

4. The method of claim 3, wherein generating the raster image data comprises bypassing the blending in response to the indicator representing no objects of the plurality of objects intersect in the given cell line.

5. An article comprising a non-transitory machine readable storage medium to store instructions that, when executed by a machine, cause the machine to:
generate an intersection table describing for each cell line of a plurality of cell lines of a document page to be printed, whether objects of the document page overlap in the cell line; and
based on the intersection table, generate raster image data for a printer.

6. The article of claim 5, wherein the storage medium stores instructions, that, when executed by a machine, cause the machine to blend source cells associated with the object for a given cell line of the plurality of cell lines based on degrees of opacity associated with the source cells.

7. The article of claim 6, wherein, for a given cell of the given cell line, the plurality of source cells are associated with a plurality of layers associated with a depth direction from a bottom layer of the plurality of layers to a top layer of the plurality of layers, and the storage medium stores instructions that, when executed by the machine, cause the machine to:
blend the source cells such that the source cells are blended in a direction from the top layer of the plurality of layers to a bottom layer of the plurality of layers.

8. The article of claim 7, wherein the storage medium stores instructions that, when executed by the machine, causes the machine to, for the given cell, halt the blending in response to one of the source cells being opaque.

9. The article of claim 5, wherein the instructions, when executed by the machine, cause the machine to:
initialize a transparent cell line; and
modify the transparent cell line based on source cells associated with the objects that intersect the given cell line.

10. The article of claim 9, wherein the storage medium stores instructions that, when executed by the machine, cause the machine to blend a document background color into the modified transparent cell line based on degrees of transparency associated with cells of the given cell line.

11. An apparatus comprising:
a processor; and
a memory to store instructions that, when executed by the processor, cause the processor to:
process a data representing a description of a page of a document associated with a plurality of cell lines and a plurality of objects to determine whether multiple objects of the plurality of objects intersect in a given cell line of the plurality of cell lines;
generate raster image data for a given cell line of the plurality of cell lines based on the determination;
communicate the raster image data to a printer; and
subsequent to the communication, generate raster image data for another cell line of the plurality of cell lines.

12. The apparatus of claim 11, wherein the instructions, when executed by the processor, cause the processor to:
in response to the indicator representing that objects of the plurality of objects intersect in the given cell line, decode data representing run length encoding of the given cell line, and generate the raster image data based on the decoded data.

13. The apparatus of claim 12, wherein the instructions, when executed by the processor, cause the processor to process the decoded data to generate data representing a blending of objects that intersect in the given cell line.

14. The apparatus of claim 13, wherein the instructions, when executed by the processor, cause the processor to run length encode the data representing the blending of the objects.

15. The apparatus of claim 11, wherein the raster image data comprises a plurality of pixel lines, and each cell line comprises multiple pixel lines of the plurality of pixel lines.
